(19) United States
(12) Patent Application Publication
(10) Pub. No.: US 2018/0202714 A1
(43) Pub. Date: Jul. 19, 2018

(54) MODULE-TYPE LED LAMP UNIT AND USE THEREOF

(71) Applicant: Heraeus Noblelight GmbH, Hanau (DE)

(72) Inventors: Stefan MEYER, Ronneburg (DE); Johanna HECK, Rodenbach (DE); Jörg DIETTRICH, Erlensee (DE); Marko HOFMANN, Hochheim (DE)

(21) Appl. No.: 15/744,773

(22) PCT Filed: Jul. 5, 2016
(86) PCT No.: PCT/EP2016/065777

§ 371 Date: Jan. 13, 2018

(30) Foreign Application Priority Data
Jul. 15, 2015 (DE) 10 2015 111 507.7
Feb. 10, 2016 (DE) 10 2016 102 279.9

(51) Int. Cl. F26B 3/28; F21V 23/06; F21V 29/83; F21V 3/06; B41M 7/00; B05D 3/06; B05D 3/02

(52) U.S. Cl. CPC F26B 3/28; F21V 23/06; F21V 29/83; F21V 3/061; F21Y 2115/10; B05D 3/067; B05D 3/0263; B41M 7/009; B41M 7/0081

(57) ABSTRACT

A multi-beam LED emitter unit is provided that combines multiple LED emitter modules, each equipped with at least one LED for emission of UV radiation of a wavelength below 430 nm or IR radiation of a wavelength above 780 nm. Each LED emitter module includes a housing equipped with a radiation exit window and is designed as an insertion assembly for a docking station. The docking station includes at least one connecting means for establishing a form-fitting mechanical connection to the housing and one plug element of an electrical plug connection. The housing includes a rear side including a mechanical counterpart corresponding to the connecting means and a counter element corresponding to the plug element. The connecting means and the corresponding mechanical counterpart are arranged such that establishing the form-fitting mechanical connection is associated with establishing an electrical connection between plug element and counter element.

### CROSS REFERENCE TO RELATED APPLICATIONS

This application is a U.S. National Phase filing of international patent application number PCT/EP2016/065777 filed Jul. 5, 2016 that claims the priority of German patent application number 102015111507.7 filed Jul. 15, 2015 and German patent application number 102016102279.9 filed Feb. 10, 2016. The disclosures of these applications are hereby incorporated by reference in their entirety.

### FIELD

The invention relates to modular LED emitter units including at least two LED emitter modules and with one connector for the supply of electrical power to the LED emitter modules, and methods of using the same.

### BACKGROUND

Certain conventional LED emitter units are self-contained units having their own electrical connector and connecting means for establishment of a force-locked or form-fitting connection to a mounting frame. Depending on the design and number of integrated LED lamps, one or more cables are needed to establish the data and electrical power connection.

The LED emitter unit for UV curing of printing inks known from EP 2 851 637 A1 has multiple LED emitter modules each equipped with a multitude of LEDs for the emission of UV light arranged adjacent to each other and grouped into multiple LED zones. Each LED zone can be switched on and off independent of the others and can be controlled with regard to the UV power, intensity, wavelength or emission time of the LED emitter modules combined in them.

However, it would be desirable to provide improved LED emitter units, and methods of using the same, overcoming one or more of the deficiencies of conventional LED emitter units.

### SUMMARY

According to an exemplary embodiment of the invention, an LED emitter unit is provided. The LED emitter unit includes at least two LED emitter modules and one connector for supply of electrical power to the LED emitter modules. Each of the LED emitter modules includes at least one LED for emission of UV radiation of a wavelength below 430 nm or of IR radiation of a wavelength above 780 nm. Each LED emitter module includes a housing equipped with a radiation exit window and is configured as an insertion assembly for a docking station. The docking station includes at least one connecting means for establishing a form-fitting mechanical connection to the housing and one plug element of an electrical plug connection. The housing includes a rear side including a mechanical counterpart that corresponds to the connecting means and a counter element that corresponds to the plug element of the electrical plug connection. The connecting means of the docking station and the corresponding mechanical counterpart of the rear side of the housing are arranged such that establishing the form-fitting mechanical connection is associated with establishing an electrical connection between the plug element and the counter element.

According to another exemplary embodiment of the invention, methods of using the LED emitter units described above are provided. For example, such LED emitter units may be used for curing at least one of an ink or a coating in a printing machine.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a perspective view of a front side of a UV-LED emitter unit designed as a triple module in accordance with an exemplary embodiment of the invention;

FIG. 2 is a perspective view of the rear side cladding of the UV-LED emitter unit of FIG. 1;

FIG. 3 is a perspective view of the UV-LED emitter unit of FIG. 1 including a pulled-out UV-LED emitter module;

FIG. 4 is a perspective view of the UV-LED emitter unit of FIG. 4 with a side part removed from the docking station;

FIG. 5 is a perspective view of a front side of a UV-LED emitter unit designed as a double module in accordance with an exemplary embodiment of the invention;

FIG. 6 is a perspective underside view of the UV-LED emitter unit of FIG. 5;

FIG. 7 is a front side view of the UV-LED emitter unit of FIG. 5;

FIG. 8 is an illustration of a locking mechanism of a docking station and an LED emitter module in accordance with an exemplary embodiment of the invention;

FIG. 9 is an illustration of an electrical and a mechanical connection of a docking station and an LED emitter module in accordance with an exemplary embodiment of the invention;

FIG. 10 is a three-dimensional depiction of a rear side of a housing of an LED emitter module in accordance with an exemplary embodiment of the invention; and

FIG. 11 is a view of an underside of a housing of an LED emitter module in accordance with an exemplary embodiment of the invention.

### DETAILED DESCRIPTION

In connection with multi-beam LED emitter units, the number of the electrical and mechanical connections tends to increases with the number of lamps included in the multi-beam LED emitter unit. The assembly and disassembly of the lamps for cleaning, maintenance or replacement purposes is associated with a major cabling effort and time expenditure. Connection errors or loose contacts may occur easily.

Emitter units with fixed lamps are usually replaced completely even if only individual components are defective. This is often the case, because replacing defective components is time-consuming such that it is common to insert a new complete emitter unit to avoid extensive downtimes.

Aspects of the invention are therefore based on the object to provide an LED emitter unit that is easy to maintain and mount, and that reduces or eliminates the above-mentioned cabling effort, and makes optimal use of the available installation space.

According to exemplary aspects of the invention, each LED emitter module includes a housing equipped with a radiation exit window and is designed as an insertion assembly for a docking station. The docking station includes at least one connecting means for establishing a form-fitting mechanical connection to the housing and one plug element of an electrical plug connection. The housing includes a rear side of the housing that includes a mechanical counterpart that corresponds to the connecting means and a counter element that corresponds to the plug element of the electrical plug connection. The connecting means of the docking station and the corresponding mechanical counter-part of the rear side of the housing are arranged appropriately such that establishing the form-fitting mechanical connection is associated with establishing an electrical connection between plug element and counter element.

Exemplary embodiments of the invention relate to LED emitter units including multiple modular insertion assemblies. These assemblies shall also be referred to as “LED emitter modules” or “single modules” hereinafter. Each of the modules includes its own housing that accommodates at least one light-emitting diode (LED), but preferably a multitude of LEDs. The housings of the LED emitter modules are arranged, for example, adjacent to each other. The housing-mounted modular design of the LED emitter units according to the invention is advantageous in that any format width for irradiation can be provided based on an LED emitter module housing of a small standard size by joining multiple of the single modules.

Each LED emitter module may include multiple LEDs that can be subdivided into one or more segments. In an embodiment of the invention, not only the LED emitter modules, but the segments also, can be controlled separate of each other, in particular can be switched on and off and can have their emission power be set, for example, be dimmed. Due to said adaptability, a failed LED emitter module having a given nominal power can be replaced by a different LED emitter module having a different nominal power without having to replace the control electronics.

Exemplary docking stations are another important foundation of the modular design of the LED emitter unit (can also be called “backplane” referring to similar components in computer and electrical engineering) by means of which the distribution of the electrical supply, and preferably the data transmission to a control also, is being implemented. Exemplary docking stations include a design adapted to the specific application of the emitter unit; for example, it comprises a lateral extension that is at least as large as the format width of the substrate to be irradiated and it is provided with a number of docking sites that corresponds to the number of single modules required to cover the format width. The single modules are designed as insertion assemblies for the docking station.

In a simple embodiment, passively cooled LED emitter modules are used. The passive cooling of the emitters is effected without forced cooling and does not require any electrical components. But the modular concept is particularly well-suited for the use of liquid-cooled or air-cooled LED emitter modules. Since the supply of the gaseous or liquid coolant can be guided centrally via the docking station. Accordingly, for example, in the case of air cooling, the aspiration or discharge of the cooling air can also be effected via the docking station.

The docking station is a passive component, which essentially provides a mounting wall facing the LED emitter modules. The mounting wall is provided with connecting and connector elements for mechanical and electrical connection of the LED emitter modules. The LED emitter modules occupy slots on the inside of the docking station. The cabling may only need to be done once and is essentially done on or within the mounting wall. The internal power distribution of the emitter unit takes place, for example, via a current distribution rail along the mounting wall. The current distribution rail is firmly integrated into the design of the emitter unit and therefore necessitates no additional component. Preferably, the data distribution also takes place via a data line running along or within the mounting wall. A lateral covering cap can be provided on one side or both sides of the mounting wall.

Due to the presence of the docking station, the individual LED emitter modules may not require connecting cables for power supply and data transmission. The modular design of the emitter unit makes it feasible, at least, to strongly reduce the number of cables required. The mounting, maintenance and replacement of single modules proceed even more easily than the replacement of a complete emitter unit. Errors in the establishment of cable connections may be excluded. If an individual LED emitter module fails, it can be replaced without much effort in a short period of time. There is no need to return the entire emitter unit to the manufacturer for repair or to call in a service technician. Consequently, there are reduced maintenance costs and downtimes.

Exemplary embodiments of the emitter units according to the invention are specified in the sub-claims. In detail:

According to an exemplary embodiment of the invention, the docking station is designed to accommodate at least three insertion assemblies of identical design and includes a number of electrical plug elements and connecting means that is equivalent to the number of LED emitter modules.

According to another exemplary embodiment of the invention, the plug elements are mounted on a common rail and are electrically connected to each other. The rail, for example, a current distribution rail, may extend on the side of the mounting wall of the docking station that faces the insertion assemblies.

According to another exemplary embodiment of the invention, the rear side of the housing and the docking station are provided with mutually corresponding guiding means that engage each other in gliding manner when the LED emitter module is being inserted into the docking station to finally effect a mechanical joined connection.

The fastening variant simplifies the implementation of a mounting of the LED emitter modules without tools.

According to another exemplary embodiment of the invention, the mechanical counterpart of the rear side of the housing includes a conically tapering guiding pin.

Inserting the LED emitter module into the docking station, the at least one guiding pin reaches a corresponding receptacle provided therein. The conical tapering simplifies the insertion; whereby it is sufficient if the outward-facing tip of the guiding pin is designed to be conical.

According to another exemplary embodiment of the invention, the housing includes a rear side of the housing, adjacent side walls, a front of the housing situated opposite from the rear side of the housing as well as a top of the housing and an underside of the housing, whereby the exit opening for the emitted light is arranged on the underside of the housing.

In another advantageous exemplary embodiment, the housing is provided with ventilation slits and the docking station is provided with ventilation openings, whereby the ventilation slits and the ventilation openings are connected such as to be in fluid communication with each other.

A gaseous coolant for cooling the single modules can be aspirated or discharged through the ventilation slits and the ventilation openings. Due to the ventilation slits and ventilation openings being in fluid communication, the coolant aspirated in one case is guided to the other site and cools the single module on this ventilation duct, for example, the LEDs contained therein.

Advantageously, the ventilation slits may extend on the top of the housing in the direction of the rear side of the housing towards the front of the housing and extend beyond the top of the housing along an upper section of the front of the housing, whereby the front of the housing arches outwards.

The rear side of the housing and the adjacent side walls may be substantially level and extend perpendicular to the underside of the housing.

The top of the housing is may be arched outwards and is provided with the ventilation slits.

In an alternative exemplary embodiment, the front of the housing is designed to be essentially planar, whereby it extends perpendicular to the underside of the housing.

Another exemplary embodiment of the LED emitter unit relates to the plug element of the electrical plug connection being designed for the transmission of data and energy.

The plug connection for mechanical connection between the LED emitter module and the docking station is includes a plug element and a counter element or of multiple plug elements and counter elements. Plug elements and counter elements are appropriately arranged on the rear side of the housing and on the docking station in a mutually corresponding manner such that establishing the form-fitting mechanical connection is associated with concurrently establishing an electric connection. In this context, concurrently shall be understood to not necessarily mean simultaneously, but automatically; without further ado. Spatially separated plug connections for the electrical connection and for the data connection can be provided. Or a single plug connection can create both the electrical connection and the data connection; in this case, this would concern a multi-function element. The plug element actually provided for the electrical connection can also establish, or contribute to, the mechanical connection between the LED emitter module and the docking station.

With regard to an optimally homogeneous intensity distribution of the UV and/or IR radiation across the row of LED emitter modules of the LED emitter unit, there may be a distance of 4 mm or less provided between the radiation exit windows of neighbouring LED emitter modules.

Due to the dense positioning of the emission exit windows of the single modules along the LED emitter unit, the intensity distribution of the radiation is particularly homogeneous. The homogeneous intensity distribution is evident in that the radiation intensity, measured at a distance of 20 mm from the plane of the emission exit windows, does not deviate by more than 15% from an average value in any location.

Another exemplary embodiment of the LED emitter unit relates to the connecting means for establishing the form-fitting mechanical connection, and the plug element of the electrical plug connection, being provided at an inside of the docking station that faces the rear side of the housing of the LED emitter module and has a lateral extension that is at least as large as the format width of the substrate to be irradiated.

The irradiation intensity of the emitter unit according to certain exemplary embodiments of the invention (measured at the exit window) is in the range of 1 to 500 Watt/cm², preferably at least 10 Watt/cm². It may be designed for industrial applications. For example, for the curing of ink or coating in a printing machine, sintering of metallic, electrically-conductive pastes (printed conductors) or for forming processes for thermoplastic materials. However, configuring it with ultraviolet LEDs makes it well-suited also for surface treatments; activation of cross-linking processes, surface activation, surface cleaning, surface modification; air treatment; odour removal, and for medical UV applications. Alternatively, the LED emitter unit according to the invention may be configured with at least one infrared LED lamp and can be used for drying processes or other heating, heat or tempering processes. Alternatively, the LED emitter unit according to the invention may be configured with at least one infrared LED lamp and at least one ultraviolet LED lamp and can be used for applications, in which both heat and UV light are needed, such as during the drying of paints, for curing of adhesives or for artificial culturing of plants.

The emitter unit according to aspects of the invention may be used not only in continuous processes and batch processes, but also as a radiation source for use with processing units with several motion axes (e.g., robots).

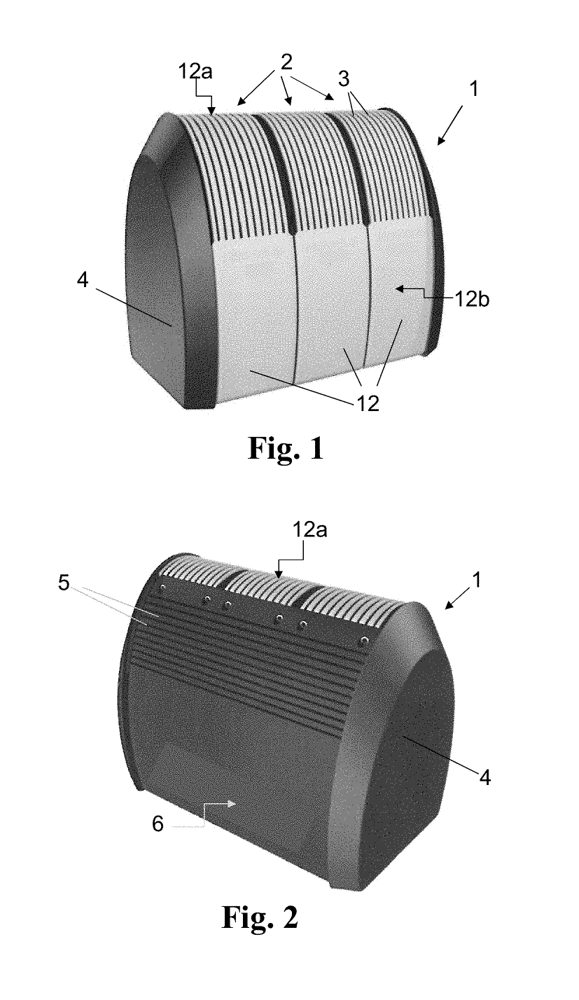

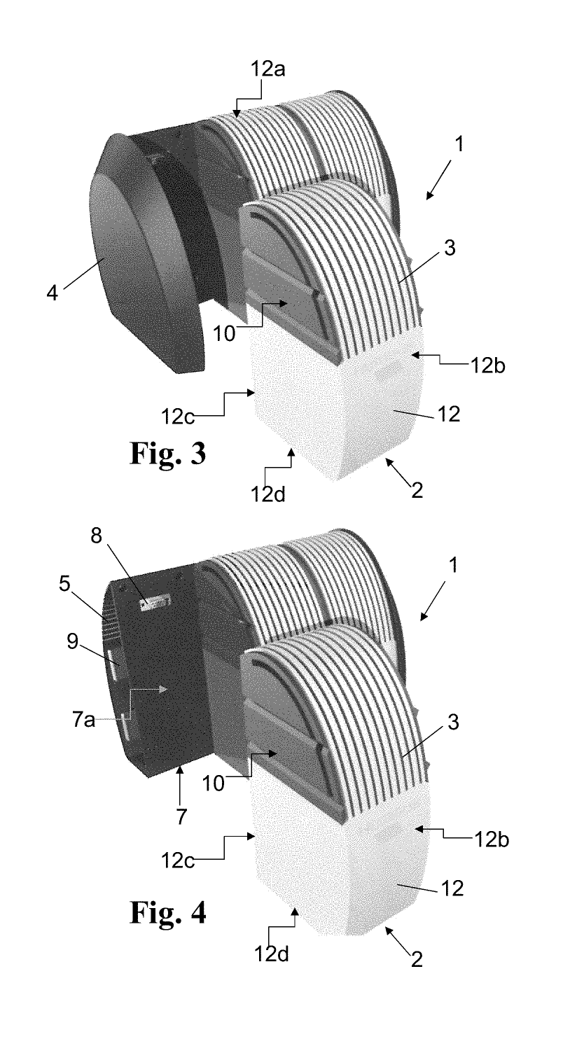

FIG. 1 shows a schematic view of an LED emitter unit 1 including three LED emitter modules 2 of identical design that are arranged adjacent to each other. The corresponding housings 12 are shown in FIG. 1 or, to be more specific, the tops 12a of the housings and the fronts 12b of the housings of the LED emitter modules 2. The sides 12a, 12b of the housing are arched outwards and are provided with a multitude of parallel-running ventilation slits 3 that extend from a planar rear side 12c of the housing (see FIG. 3) to the front side 12b. The LED emitter unit 1 is closed off by lateral cover caps 4 on both sides.

A rear-side cladding 6 is evident in the view of the rear of the LED emitter unit 1 shown in FIG. 2. The upper region of the cladding 6 is provided with multiple ventilation slits 5 that extend perpendicular to the ventilation slits 3 on the top 12a of the housing. The rear-side cladding 6 covers a docking station 7 that shall be illustrated in more detail below.

The view of the LED emitter unit 1 shown in FIG. 3 shows a pulled-out LED emitter module 2 that is provided as an insertion assembly. With the side part 4 taken off, as shown in FIG. 4, the inside 7a of the docking station 7 that faces the emitter modules 2 and has the ventilation slits 5 can be seen. It is provided with an electrical connection element 8 in the form of an adapter that also includes connecting pins for data transmission. The LED emitter module 2 includes a corresponding adapter whose arrangement is selected appropriately such that it corresponds to the corresponding adapter 8 of the docking station 7.

Cooling air for cooling the LEDs 55 (see FIG. 11) is aspirated through the ventilation slits 3. For this purpose, each LED emitter module 2 of this exemplary embodiment has its own ventilator. The aspirated cooling air is discharged centrally, fully or at least in part, via the docking station 7. For this purpose, the docking station 7 includes the ventilation openings 5. Part of the cooling air can also be discharged via the ventilation slits 3 or other openings of the LED emitter module 2. In reverse, cooling air can be aspirated via a central ventilator in a docking station 7 and can be discharged via the ventilation slits 3 of the LED emitter modules 2.

When the LED emitter module 2 is being inserted, lateral guide rails 10 on one side of the emitter module 2 engaged corresponding guide elements of the neighbouring unit. The neighbouring unit is either another LED emitter module 2 or the closing covering cap 4 of the docking station 7. Electrical plug connections (adapter 8) are generated automatically during the inserting process and are capable of transmitting both electrical current and data. The power supply lines of all emitter modules 2 extend to a common current distribution rail 9 that extends in a through-going hollow space of the docking station 7 from a side cap 4 to the other side cap 4. Likewise, the data communication lines of the LED emitter module are combined in a common data line that extends inside the docking station. Current distribution rail and data line leads to a central lamp supply and control unit. The electrical plug connection serves for establishing the power supply for the electronics of the LED module, for the LEDs and for any cooling mechanism, for example, a fan. The electronics incorporated into the insertion assemblies serve, for example, for controlling a fan and for recording error protocols.

The current distribution rail can be fabricated from a single part or multiple parts.

The lateral extension of the docking station 7 corresponds to the format width of the substrate to be irradiated. In the exemplary embodiment of FIG. 1, the substrate has a width of 225 mm that is fully covered by three LED emitter modules 2 that are arranged adjacent to each other and have a width of 75 mm each. The housings 12 of the single modules 2 are tightly spaced such that the distance between the corresponding radiation exit windows 51 (see FIG. 11 for a two-module LED emitter unit) of the single modules 2 is less than 4 mm. This results in a homogeneous intensity distribution in the direction of the Lang “L” of the emitter unit 1 that is evident in that the radiation intensity, measured at a distance of 20 mm from the plane of the emission exit windows 51, does not deviate by more than 15% from an average value in any location. The housing of the LED emitter unit 1, which therefore is composed of the docking station 7 and all of the housings 12 of the single modules 2, therefore is the result of connecting docking station 7 and all of the insertion assemblies 2.

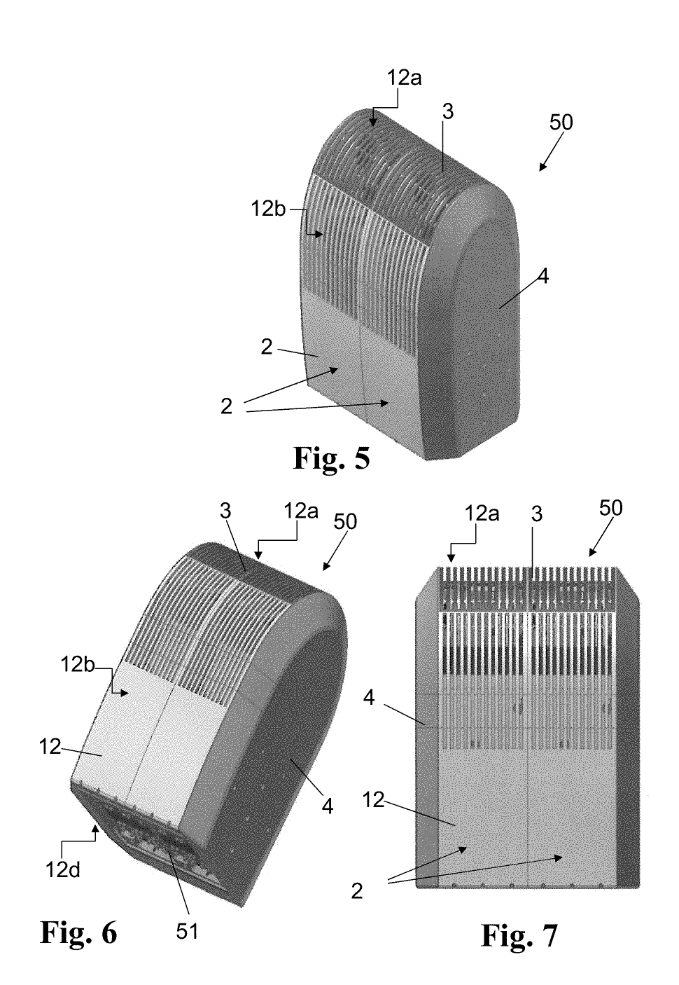

The LED emitter unit 50 of FIG. 5 is provided as a double module. Identical or equivalent components are identified by the same reference numbers as in FIGS. 1 to 4. The position of the transparent exit window 51 for the radiation emitted by the LED is identified in the view of the underside 12d of the single modules 2 according to FIG. 6 and also in FIG. 11. FIG. 7 shows the same embodiment of the UV-LED emitter unit 50 in the form of a frontal view of the front side of the single modules 2.

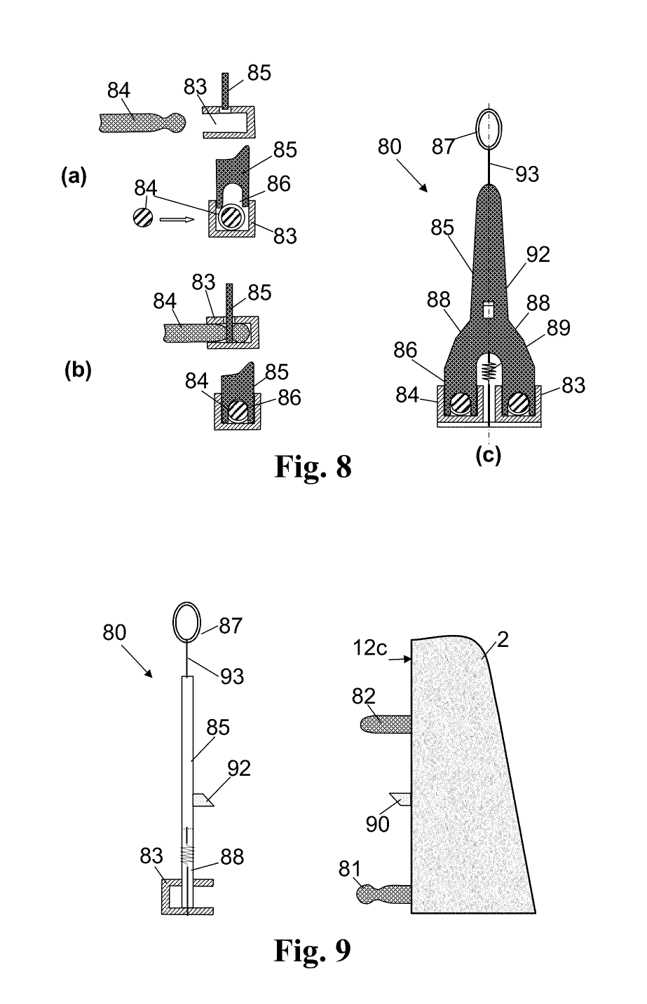

Alternatively or in addition to the guide rail 10 described above based on FIGS. 3 and 4, it is particularly preferred to have a locking mechanism that enables individual tool-free locking and unlocking of each LED emitter module 2 and docking station 7, thus preventing inadvertent detachment and allowing replacements to be done without tools. FIGS. 8 and 9 illustrate emitter module elements and docking station elements of the locking mechanism and their mode of function in more detail. Two locking pins 81, which taper lightly to the outside, stick out perpendicularly from the rear side 12c of the LED emitter module 2 facing the docking station 7. They correspond to corresponding receptacles 83 of a lock 80 that extends inside the docking station (backplane) and/or on another inside 7a. The locking pins 81 have, on their free end that protrudes into the receptacle 83, a circumferential groove 84 that is engaged in the locked state by an end 86 of a bar 85, whereby the end 86 opens downwards in the shape of a U. The bar 85 extends inside the docking station 7 such as to be axially mobile and is connected by means of a steel cable 93 to a tab 87 that is guided out of the docking station top. The bar 85 is held in the locked position by means of a spring 89 as shown schematically in sketch (b) of FIG. 8 and can be transitioned to the unlocked position by an axial upward motion by pulling on the tab 87 against the spring force, as is shown in sketch (a) of FIG. 8. As is evident from sketch (c) of FIG. 8, the bar 85, as seen from top to bottom, branches into two legs 88, which each end in the above-mentioned U-shaped end 86. A wedge 92 with a slanted surface that is oriented upwards is fastened to the bar above the branching site of the two legs 88. A counterpart 90 of the actually mobile wedge 92 is fixed in space and has a slanted surface that is oriented downwards and is situated on the side of the LED emitter module 2. Upon unlocking (upon the upward motion of the wedge 92), the slanted surface of the wedge 92 facing upward contacts from below the slanted surface of the counterpart 90 facing downward, which results in a force component acting in the direction of the rear side 12c of the lamp and in a gliding motion that pushes the unlocked emitter module 2 a little ways from its bracketing such that it can be removed more easily from the docking station 7 for replacement purposes.

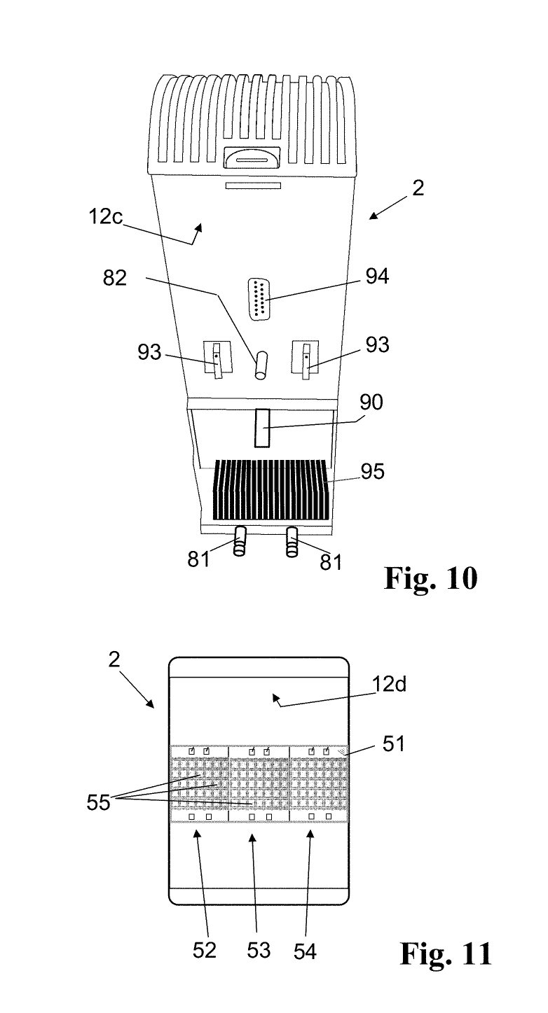

FIG. 10 shows the emitter module elements of the locking mechanism, namely the two locking pins 81 and the counterpart 90 for the expelling wedge 92. In addition, another guide pin 82, which is laterally offset, can be seen and corresponds to a corresponding socket (not shown) on the docking station 7. The guide pin 82 can just as well be an element of the locking mechanism, whereby it is provided with a circumferential grew like the locking pins 81, if applicable, and has the lock 80 on the docking station 7 as a corresponding counterpart of the receptacle 83. The electrical connection between LED emitter module 2 and docking station 7 is effected through 2-pin L parts 93 and the data connection is effected through a common 15-pin sub-D connector 94. Moreover, each single module 2 is equipped with a passive cooler 95 and a fan (not shown).

Each of the LED emitter modules 2 is equipped with a multitude of light emitting diodes 55 (LEDs). The light exit opening is provided on the rear side 12d of the housing of the LED modules 2, as is schematically shown in FIG. 11 by way of an exemplary embodiment. The total of 210 LEDs 55 are combined into three zones 52, 53, and 54 of 70 LEDs each. The LEDs of the zones 52, 53, 54 can be addressed and their power can be controlled independently of each other. The entire LED arrangement is covered by an exit window 51 made of quartz glass (transparent). The irradiation intensity of the emitter unit 1 (measured at the exit window 51) is 14 Watt/cm².

In the present exemplary embodiment, all LEDs 55 emit light from the ultraviolet wavelength range (UV) below 430 nm.

In an alternative embodiment, at least one of the LED emitter modules 2 is equipped with LEDs that emit light from the infrared wavelength range (IR). The infrared spectral range is the wavelength range between 780 nm and 1 mm. In this case, it is preferred that all LEDs 55 of the LED emitter unit 1 are IR LEDs.

In another alternative embodiment, at least one of the LED emitter modules 2 is equipped with LEDs that emit light from the visible wavelength range. The visible spectral range is the wavelength range between 380 nm and 780 nm.

In another alternative embodiment, at least one of the LED emitter modules 2 is equipped with LEDs that emit light from the ultraviolet wavelength range and with LEDs that emit light from the infrared wavelength range.

Although the invention is illustrated and described herein with reference to specific embodiments, the invention is not intended to be limited to the details shown. Rather, various modifications may be made in the details within the scope and range of equivalents of the claims and without departing from the invention.

1. An LED emitter unit comprising:
at least two LED emitter modules; and
one connector for supply of electrical power to the LED emitter modules,
wherein each of the LED emitter modules includes at least one LED for emission of UV radiation of a wavelength below 430 nm or of IR radiation of a wavelength above 780 nm,
wherein each LED emitter module includes a housing equipped with a radiation exit window and is configured as an insertion assembly for a docking station,
whereby the docking station includes at least one connecting means for establishing a form-fitting mechanical connection to the housing and one plug element of an electrical plug connection,
wherein the housing includes a rear side including a mechanical counterpart that corresponds to the connecting means and a counter element that corresponds to the plug element of the electrical plug connection,
whereby the connecting means of the docking station and the corresponding mechanical counterpart of the rear side of the housing are arranged such that establishing the form-fitting mechanical connection is associated with establishing an electrical connection between plug element and counter element.

2. The LED emitter unit of claim 1, wherein the docking station is designed to accommodate at least three LED emitter modules of identical design and includes a plurality electrical plug elements and connecting means that is equivalent to the number of LED emitter modules.

3. The LED emitter unit of claim 2, wherein the plug elements are mounted on a common rail and are electrically connected to each other.

4. The LED emitter unit of claim 1 wherein the rear side of the housing and the docking station are provided with mutually corresponding guiding means that engage each other in gliding manner when the LED emitter module is being inserted into the docking station to effect a joined connection.

5. The LED emitter unit of claim 1 wherein the mechanical counterpart of the rear side of the housing includes a conically tapering guiding pin.

6. The LED emitter unit of claim 1 wherein the housing includes the rear side of the housing, adjacent side walls, a front of the housing situated opposite from the rear side of the housing as well as a top the housing and an underside of the housing, whereby the exit opening for the emitted light is arranged on the underside of the housing.

7. The LED emitter unit of claim 6, wherein the rear side of the housing and the adjacent side walls are substantially level and extend perpendicular to the underside of the housing.

8. The LED emitter unit of claim 1 the housing is provided with ventilation slits and the docking station is provided with ventilation openings, and in that the ventilation slits and the ventilation openings are connected such as to be in fluid communication with each other.

9. The LED emitter unit of claim 8, wherein the ventilation slits extend on the top of the housing in the direction of the rear side of the housing towards the front of the housing and extend beyond the top of the housing along an upper section of the front of the housing, whereby the front of the housing arches outwards.

10. The LED emitter unit of claim 8 wherein the front of the housing is designed to be substantially planar and extends perpendicular to the underside of the housing.

11. The LED emitter unit of claim 1 wherein the plug element of the electrical plug connection is designed for the transmission of data and/or energy.

12. The LED emitter unit of claim 1 wherein there is a distance of 4 mm or less provided between the radiation exit windows of neighbouring LED emitter modules.

13. The LED emitter unit of claim 1 wherein the connecting means for establishing the form-fitting mechanical connection and the plug element of the electrical plug connection are provided at an inside of the docking station that faces the rear side of the housing of the LED emitter module and has a lateral extension that is at least as large as a format width of a substrate to be irradiated.

14. The LED emitter unit of claim 13, wherein the inside of the docking station is closed off by lateral cover caps on its longitudinal sides.

15. A method of using an LED emitter unit comprising the steps of:
(a) providing an LED emitter unit of claim 1; and
(b) using the LED emitter unit for curing at least one of (i) and ink or (ii) a coating in a printing machine.

16. The LED emitter unit of claim 2 wherein the rear side of the housing and the docking station are provided with mutually corresponding guiding means that engage each other in gliding manner when the LED emitter module is being inserted into the docking station to effect a joined connection.

17. The LED emitter unit of claim 3 wherein the rear side of the housing and the docking station are provided with mutually corresponding guiding means that engage each other in gliding manner when the LED emitter module is being inserted into the docking station to effect a joined connection.

18. The LED emitter unit of claim 2 wherein the mechanical counterpart of the rear side of the housing includes a conically tapering guiding pin.

19. The LED emitter unit of claim 3 wherein the mechanical counterpart of the rear side of the housing includes a conically tapering guiding pin.

20. The LED emitter unit of claim 4 wherein the mechanical counterpart of the rear side of the housing includes a conically tapering guiding pin.
